(19) United States
(12) Patent Application Publication
(10) Pub. No.: US 2025/0236302 A1
(43) Pub. Date: Jul. 24, 2025

(54) Vehicle Mobility Prediction System

(71) Applicant: Hodges Transportation, Inc., Silver Springs, NV (US)

(72) Inventors: Henry Hodges, JR., Carson City, NV (US); Derrick Capps, Fernley, NV (US); Reid Pulley, Silver Springs, NV (US); John McComber, Carson City, NV (US)

(21) Appl. No.: 19/173,764

(22) Filed: Apr. 8, 2025

Related U.S. Application Data
(63) Continuation-in-part of application No. 17/017,422, filed on Sep. 10, 2020, now abandoned.
(60) Provisional application No. 62/898,305, filed on Sep. 10, 2019.

(51) Int. Cl. B60W 50/00; B60W 50/14; G01C 21/00; G01C 21/34; G01C 21/36

(52) U.S. Cl. CPC B60W 50/0097; B60W 50/14; G01C 21/3415; G01C 21/3667; G01C 21/3826; B60W 2050/146

(57) ABSTRACT

A motor vehicle that features a dynamic vehicle mobility prediction system (VMPS) that uses a real-time 3D multibody physics-based simulation to analyze vehicle-terrain interactions. It dynamically adjusts vehicle components, including tire pressure, suspension height, power distribution, wheel speed, and traction control settings, to optimize grip, reduce sinkage, and maintain forward motion over challenging terrains. The vehicle is equipped with a vehicle control computer that manages acceleration and braking and is integrated with the vehicle's navigational systems, GPS, and sensors for precise movement. The vehicle control computer receives data and instructions from the dynamic VMPS that includes an onboard vehicle simulation module for real-time vehicle dynamics and terrain interactions, a deformable terrain soil program to assess vehicle to soil reactions, a tire/track soil interaction library, a digital terrain representation program offering a 3D model of the terrain, and a global positioning sensor used to determine the vehicle's position and speed relative to the digital terrain model. The dynamic VMPS is configured to identify possible travel routes and assigns a predictive value to each route. Routes with high and low predictive values are identified and presented to the vehicle operator as ‘Go/No-Go’ travel routes.

This utility patent application is a continuation-in-part application based on U.S. utility patent application (application Ser. No. 17/017,422) filed on Sep. 10, 2020, which is based on and claims the filing date benefit of U.S. provisional patent application (Application No. 62/898,305) filed on Sep. 10, 2019.

Notice is hereby given that the following patent document contains original material subject to copyright protection. The copyright owner has no objection to the facsimile or digital download reproduction of all or part of the patent document but otherwise reserves all copyrights.

### FIELD AND BACKGROUND OF THE INVENTION

### Field of the Invention

The present application relates to motor vehicles equipped with adaptive vehicle control and onboard terramechanics technologies, enabling continuous terrain monitoring, real-time performance adjustments, and intelligent path optimization to ensure optimal mobility and efficiency across varying terrains while also proactively identifying and avoiding “No Go” areas to enhance maneuverability and safety.

### Background of the Invention

Operating vehicles in off-road environments poses significant challenges for both the vehicle operator and the vehicle, as paths or routes may be obstructed or altered by physical barriers like fallen trees, rocks, landslides, and weather-related obstacles such as wind, standing or runoff water, ice, or snow. Weather-related challenges can also result in soft soil or ruts that impede travel. For instance, a typically dry trail suitable for summer use may become much more difficult during wet seasons due to heavy rain. Flash floods can create ruts or dips in the route, which can cause the vehicle to become ‘high centered.’ Conditions can change suddenly while the vehicle is moving, necessitating continuous monitoring and adjustments to both the vehicle and its travel path to ensure it reaches the intended destination.

Military vehicles built for off-road travel feature heavy-duty transmissions, suspensions, central tire inflation systems, steering and braking systems, drivelines, and specialized axles. Continuous monitoring of these components is crucial as the vehicle traverses various terrains. Since drivers are already preoccupied with steering and maneuvering, an automated system to observe and manage these components would be beneficial. The level of control or adjustment the system offers may vary between vehicles, depending on factors like weight or configuration, such as trailer towing, which complicates the vehicle operator's ability to determine the vehicle's optimal performance.

Military vehicles often include terra-mechanical systems or components that enable the vehicles to traverse rugged terrains, like mud, sand, snow, and rocks, while maintaining stability, traction, and durability. For wheeled vehicles, the terra-mechanical systems may include all-wheel drive systems, central tire inflation systems, hydro-pneumatics suspensions, the use of torsion bar suspension, skid plates, anti-skid traction systems, active torque vectoring, and drivetrain adjustment systems. A vehicle's central control unit (CCU) usually manages these terra-mechanical systems to optimize performance.

Military vehicles may also include a static vehicle mobility prediction system to assess whether a vehicle can successfully traverse a given terrain based on precomputed terrain data, soil properties, and vehicle performance characteristics. The static vehicle mobility prediction systems used in military vehicles are static systems, meaning they utilize preloaded terrain and soil databases derived from satellite imagery, ground surveys, and past mobility studies. They depend on fixed mobility models that assume constant terrain conditions and do not update predictions once the vehicle is in motion or encounters unexpected obstacles. While these systems provide valuable pre-mission planning insights, they may not reflect real-time changes in terrain due to weather, environmental shifts, or combat damage, limiting their ability to adapt to unpredictable conditions.

An example of a static vehicle mobile prediction system is disclosed in U.S. Patent Application 2014/0257621 (Zych), which uses a terrain classification system. The terrain classification system utilizes sensors (LIDAR, RADAR, cameras, and microphones) to analyze and classify the surrounding terrain based on its acoustic properties. The terrain classification system uses an acoustic cost map, which assigns values to different terrain areas based on the expected noise generated when a vehicle moves over them. While moving, the vehicle uses the acoustic cost map to identify routes that minimize acoustic output. This allows vehicles to travel more stealthily and efficiently, particularly in military or autonomous operations where noise reduction is critical. By evaluating a library of acoustic map data, the system creates an acoustic cost map that predicts the expected noise level generated by a vehicle moving over different terrains.

Using acoustic cost maps for terrain classification and vehicle route optimization presents advantages in stealth and environmental awareness. However, the accuracy and reliability of such systems are highly dependent on environmental conditions, preexisting data, and real-time processing capabilities. These limitations suggest that acoustic-based terrain classification should ideally be supplemented with other mobility prediction methods (such as visual, LIDAR, or soil deformation analysis) for improved performance.

What is needed is a dynamic vehicle mobile prediction system that operates continuously in real time, that monitors not only the vehicle's movement but also monitors the response of the terrain as the vehicle moves over the terrain. What is needed is a dynamic vehicle mobility prediction system that continuously monitors the vehicle's movement over the terrain, continuously evaluates the terrain and soil conditions, and continuously assesses the vehicle's capability to continue along the current route. When a route is identified as a ‘No Go’ route, the system stops movement and provides alternative ‘Go’ routes. What is also needed is a dynamic vehicle mobility prediction system that can be easily installed in military vehicles with existing static vehicle mobility prediction systems.

### SUMMARY OF THE INVENTION

The invention is a dynamic vehicle mobility prediction system installed in a vehicle designed to be driven over rugged terrain by a vehicle operator inside or remotely. The dynamic vehicle mobility prediction system (hereinafter known as dynamic VMPS) is a comprehensive system designed to predict and manage vehicle mobility over challenging terrains. The dynamic VMPS, when incorporated into a motor vehicle, establishes the vehicle's ability to proceed over different subsurface terrain conditions. When a deformable terrain surface exists, the vehicle's motion causes the vehicle's tire or track to penetrate that surface and make contact with the subsurface material. As the vehicle moves, the subsurface material is displaced downward and to the front, rear, and sides of the tire or track. The dynamic VMPS measures the subsurface condition of a deformable terrain and uses several software programs and other sensor data to determine whether the vehicle can maintain a ‘Go’ condition on the path selected by the vehicle operator.

The ability of the vehicle to continue motion as directed by the vehicle operator over the terrain surface is identified as a ‘Go’ condition. When the dynamic VMPS determines that travel is beyond the vehicle's capabilities, the movement is stopped and the route is deemed a ‘No Go’ route. When a predicted ‘No Go’ condition occurs, the vehicle is immobilized and cannot continue the path selected by the vehicle operator. This situation is adverse to the intended use of the vehicle and is intentionally avoided during vehicle operation. The observed surface of a deformable terrain, whether visually, digitally, acoustically, or through other means, does not provide the necessary information to the operator to identify whether the vehicle can or cannot continue. The dynamic VMPS continuously updates the vehicle's status, determining whether a ‘No Go’ condition is imminent and warning the operator so that the selected path may be adjusted to avoid the ‘No Go’ condition.

The dynamic VMPS is intended to be used with motor vehicles with a plurality of sensors that measure the vehicle's temperature, pressure, amount of vehicle load, speed of vehicle, and voltage/amperage. The sensors are connected to an existing real-time multiple-device, bidirectional digital communication network (also called BUS) or a replacement BUS compatible with the dynamic VMPS.

More specifically, the dynamic VMPS includes a vehicle control computer (hereinafter known as a VCC). The dynamic VMPS also includes two programs-a Vehicle Three-dimensional Multibody Physics-based Program (also called a simulation), and a deformable terrain and a subsurface soil program. The dynamic VMPS also includes a Tire/Track Soil Interaction Library that provides data on soil interactions, a Digital Terrain Representation Program that offers a 3D model of the terrain, and a Global Positioning Sensor that determines the vehicle's position and speed relative to the terrain model. The two software programs, the Tire/Track Soil Interaction Library, the Digital Terrain Representation Program, and the Global Positioning Sensor can be installed in a separate VMPS unit or installed or connected directly to the VCC.

The dynamic VMPS also includes a Navigation Subsystem, which guides the vehicle, and the Obstacle Avoidance System, which detects and avoids obstacles. Both the Navigation Subsystem and the Obstacle Avoidance System communicate with the VCC and the programs and with the dynamic VMPS. During operation, the VCC integrates all of these components and works together to process data and provide real-time feedback and adjustments to optimize vehicle performance.

The dynamic VMPS also includes a plurality of integrated control subsystems installed in the vehicle and connected to the BUS. The control subsystems include the following subsystems: an Engine/Generator Subsystem, a Transmission Subsystem, a Suspension Subsystem, a Tire Monitoring/Adjustment Subsystem, a Mobility Control Subsystem, and a Powertrain Control Subsystem.

During use, the VCC continuously collects data from sensors and external sources, spatial information from the map database, and datum from the onboard vehicle simulation model, the deformable terrain soil program, the tire/track soil interaction library, the Digital Terrain Representation Program, and the Global Positioning Sensor. The dynamic VMPS units' software programs access the interaction between the vehicle and the subsurface soil conditions and use algorithms and simulations to assess the vehicle's current state and predict future performance. Based on the analysis, the VCC sends control commands to adjust the vehicle's subsystems.

An important feature of the dynamic VMPS is its ability to identify possible travel routes and assign predictive values to each route, presenting them as ‘Go/No-Go’ travel routes. When the vehicle moves along a route, the dynamic VMPS continuously assesses the interaction between the vehicle and the subsurface soil conditions. It also assesses the vehicle's capability to navigate subsurface soil conditions and determines whether the vehicle can maintain movement on its current or alternative routes. Routes that the vehicle can follow are deemed ‘Go’ routes. If the vehicle is currently on a ‘Go’ route, the vehicle may continue the ‘Go’ route. If the dynamic VMPS integrated use of software, and database information determines that the route, by assessing the interaction between the vehicle and the subsurface soil, is beyond the vehicle's capabilities, the route is identified as a ‘No-Go’ route, and the vehicle is directed either to stop or follow an alternative ‘Go’ route. The dynamic VMPS updates the vehicle's status and may alert the operator to potential ‘No-Go’ conditions, enabling manual route adjustments.

An example of the dynamic VMPS at work is seen when the vehicle is moving along a route. The vehicle's motion can cause the tire or track to penetrate the surface when a deformable terrain surface is present, resulting in sinkage and contact with subsurface material. The dynamic VMPS measures subsurface conditions in real-time, providing crucial information to determine if the vehicle can maintain a ‘Go’ condition. It continuously updates the vehicle's status, alerting the operator to potential ‘No-Go’ conditions, which enables path adjustments to prevent immobilization. The dynamic VMPS operates continuously, receiving and processing real-time vehicle data, terrain characteristics, and soil mechanics to provide the operator with actionable insights. The simulation provides a model of the real-time interaction between the vehicle and the terrain. It predicts how the vehicle will behave in different soil conditions such as soft sand, mud, and rocky terrain. It calculates whether the vehicle has enough tractive power to continue moving and provides dynamic updates as it moves and encounters new terrain.

By evaluating multiple travel paths and assigning predictive values, the dynamic VMPS provides the operator with a clear understanding of each route's potential risks and benefits. This information enables the operator to make informed decisions, selecting the path that best aligns with the mission objectives and current conditions. Predictive values help identify ‘Go’ and ‘No-Go’ routes, allowing the dynamic VMPS to highlight paths that are safe to travel and those that pose significant risks. This capability is essential for avoiding routes that could lead to vehicle immobilization, damage, or other operational failures, thereby enhancing the overall safety and reliability of the vehicle's operation. The dynamic VMPS ensures that the vehicle can adapt to changing terrain and environmental conditions in real-time by continuously assessing and updating the predictive values of various routes. This dynamic optimization helps maintain optimal vehicle performance, reducing the likelihood of encountering obstacles or difficult terrain that could hinder progress. Providing the operator with predictive values for different routes reduces the cognitive load and stress of navigating challenging terrains. The dynamic VMPS offers actionable insights and recommendations, supporting the operator in making the best possible decisions under varying conditions.

### BRIEF DESCRIPTION OF THE DRAWINGS

FIG. 1 is an illustration of a motor vehicle driven by an on-board or remote operator. The motor vehicle includes an integrated vehicle management system that monitors, controls, and coordinates various functions and subsystems of the vehicle, such as, a mechanical control system (brakes, gear shifting, throttle control), and a communication data highway, called a BUS configured to exchange data and commands over a shared network. Also shown is a communication network 22 enabling the operator to communicate with outside sources or allow remote operators to control the motor vehicle.

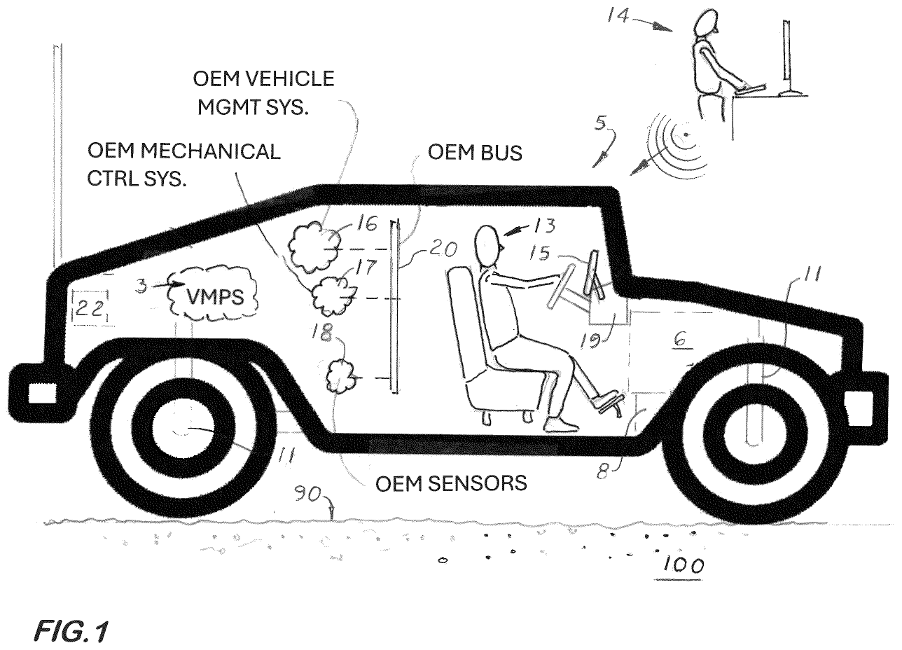

FIG. 2 is a block diagram of the dynamic VMPS.

FIG. 3 is data flow diagram showing how the dynamic VMPS collects data from the Vehicle 3-Dimensional Multibody Software Program, the Deformable Terrain Soil Program, the Terrain Data and the Vehicle Ground Speed sources, and combines it with Wheel/Track Speed or Wheel/Track Power data to generate a Mu slip graph which is then used to provide Go/No Go output to the operator.

FIG. 4 is an illustration showing the measurements of the tire/track interacting with the soil.

FIG. 5 is an illustration showing the forces exerted on a tire/track interacting with the soil shown in FIG. 4.

FIG. 6 is a graph showing the Vehicle Tractive Performance with Respect to Wheel/Track Slip.

FIG. 7 is a graph showing the conversion of TE vs Slip to τ vs j.

FIG. 8 is a flow chart showing the Vehicle 3-Dimensional multibody dynamic simulation data being combined with the Tire/Track Soil interaction data to create the Vehicle 3-dimensional multibody dynamics soil simulation program.

FIG. 9 shows four-layered Illustrations of Local GIS Terrain Data loaded into the VMPS program.

FIG. 10 is a high-resolution GIS Data.

FIG. 11 illustrates ‘Go’ (White) or ‘No Go’ (Black) Terrain Sections based on soil strength.

FIG. 12 illustrates ‘Go’ (White) or ‘No Go’ (Black) Terrain Sections Based on Slope.

FIG. 13 illustrates ‘Go’ (White) or ‘No Go’ (Black) Terrain Sections Based on Slope and Soil Condition.

FIG. 14 illustrates ‘Go’ (White) or ‘No Go’ (Black) terrain sections based on roughness.

FIG. 15 illustrates Go' (White) or ‘No Go’ (Black) terrain sections based on slope, soil condition, and roughness.

FIG. 16 illustrates the VMPS continuous analysis for ‘Go’ and ‘No Go’ terrain sections as the vehicle moves over the terrain.

### DESCRIPTION OF THE PREFERRED EMBODIMENT(S)

Disclosed herein is a dynamic vehicle mobility prediction system 3 (hereinafter known as dynamic VMPS), a technology that substantially improves the capability and efficiency of ground vehicles during operation over naturally occurring terrains, where deformation and displacement of the surface occur due to the motion of the vehicle system.

The current design and operation of vehicles heavily rely on significant operator intervention to select seemingly appropriate vehicle configurations and associated operational paths. This process does not optimize the integration of vehicle capabilities or provide the best terrain interaction for intended operations, consequently compromising the assurance of optimal operational outcomes. This can lead to vehicle immobilization, failure, and increased risks to personnel and vehicle systems, especially in a “must complete” military operational environment.

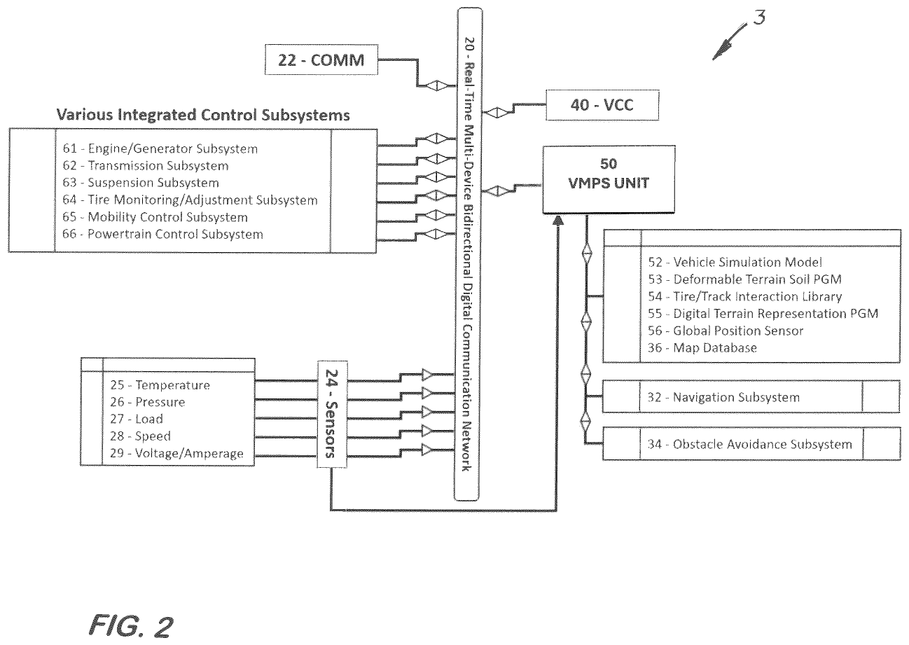

Referring to FIG. 2, the invention is a dynamic VMPS 3 that integrates various components and subsystems in the vehicle 5 to manage and optimize vehicle performance over terrain 90 in real time. At the core of this system 3 is the Vehicle Control Computer (VCC) 40 that may be connected to a hardware component, called a VMPS unit 50. The VCC 40 uses or receives outputs from two programs-a Three-Dimensional Multibody physics-based program (also called a Vehicle Simulation Model) 52 and a Deformable Terrain Soil Program 53. The VCC 40 also uses or receive data from a Tire/Track Soil Interaction Library 54 that provides data on soil interactions, a Digital Terrain Representation Program 55 that offers a 3D model of the terrain 90, and a Global Positioning Sensor 56 that determines the vehicle's position and speed relative to the terrain model. During use, VCC 40 uses the programs 52, 53, 55, Library 54, and Sensor 56 to analyze real-time vehicle dynamics and terrain. It continuously updates travel routes, identifies obstacles, and provides real-time recommendations to the vehicle operator 13 or 14. It should be understood that the software programs 52, 53, and 55, the Library 54, and Global Positioning Sensor 56 may be stored or connected directly to the VCC.

The vehicle 5 includes a plurality of sensors, generally indicated by the reference number 24. The sensors include the vehicle's Temperature sensor 25, Atmosphere pressure 26, Vehicle Load Sensor 27, Vehicle Speed Sensor 28, and Vehicle Voltage/Amperage Sensor 29. As shown in FIG. 2, all of the sensors are communicating with a BUS 20.

The dynamic VMPS 3 also includes a plurality of integrated control systems installed in the vehicle 5 and connected to the BUS 20. The control subsystemS includes the following: an Engine/Generator Subsystem 61, a Transmission Subsystem 62, a Suspension Subsystem 63, a Tire Monitoring/Adjustment Subsystem 64, a Mobility Control Subsystem 65, and a Powertrain Control Subsystem 66. During use, the dynamic VMPS 3 adjusts the throttle, the RPM level, torque limiting power control, and temperature derating to manage power delivery, based on the vehicle's operational conditions. The dynamic VMPS 3 may also control the gear lockout, torque converter lockup, downshift, and upshift commands to optimize torque and speed distribution to the wheels (not shown). The dynamic VMPS 3 commands the ride height and suspension compliance levels to maintain vehicle stability and ride comfort based on terrain conditions. The dynamic VMPS 3 adjusts tire inflation pressure to optimize traction and ride quality, ensuring the vehicle can maintain grip on various terrain types. The dynamic VMPS 3 engages intra-or inter-axle driver locks to increase mobility performance, ensuring the wheels turn at the same speed in off-road conditions. And, the dynamic VMPS 3 manages the power distribution from the engine or electric motor to the wheels or tracks, optimizing power delivery for maintaining vehicle mobility over deformable terrain.

When the dynamic VMPS 3 is assembled in a vehicle 5, the vehicle 5 can proceed continuously over different subsurface terrain conditions. When a deformable terrain surface exists, the vehicle's motion causes the tire or track to penetrate that surface. The resultant sinkage of the vehicle 5 causes the tire or track to be in contact with the subsurface material. Due to the vehicle's motion, the subsurface material is displaced downward and to the front, rear, and sides of the tire or track. The ability of vehicle 5 to continue motion as directed by the vehicle operator over the terrain surface is identified as a ‘Go’ condition. The inability of the vehicle to continue said motion over the terrain surface is identified as a ‘No Go’ condition.

When a predicted ‘No Go’ condition occurs, the vehicle is immobilized and cannot continue the path the operator selects. This situation is adverse to the vehicle's intended use and is intentionally avoided during vehicle operation. The observed surface of a deformable terrain, whether visually, digitally, acoustically, or through other means, does not provide the necessary information to the operator to identify whether the vehicle can or cannot continue. The dynamic VMPS 3 measures the subsurface condition of a deformable terrain as the vehicle is in motion and uses that unique information to determine whether the vehicle can maintain a ‘Go’ condition on the path selected by the vehicle operator. The dynamic VMPS 3 continuously updates the status of the vehicle, determining whether a ‘No Go’ condition is imminent and providing a warning to the vehicle operator so that the selected path may be adjusted to avoid the ‘No Go’ condition.

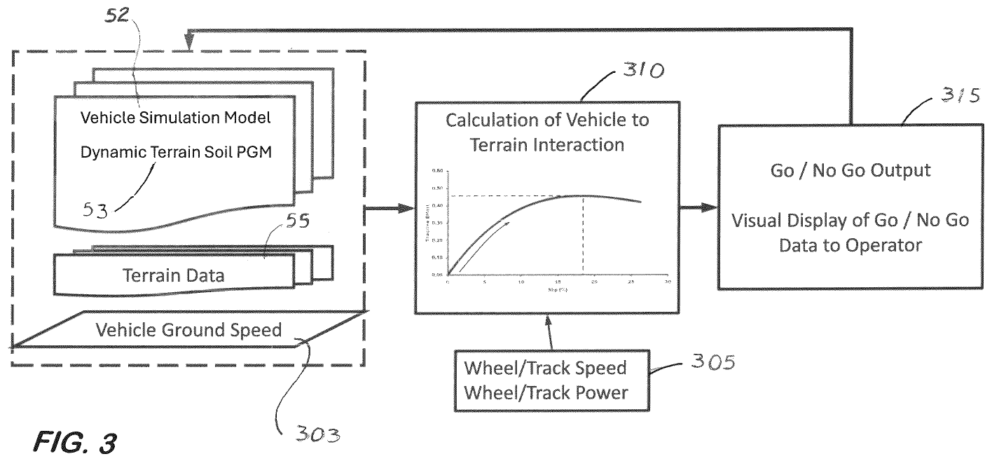

Referring to FIG. 3, the Vehicle Simulation Model 52 and the Dynamic Terrain Soil PGM 53 focus on the interaction between the vehicle 5 and the deformable soil 100. The Vehicle Simulation Model 52 contains the simulations of all the dynamic elements of the vehicle 5 that are active when the vehicle 5 is in motion.

Also, as the Vehicle Simulation Model 52 and the Dynamic Terrain Soil PGM 53 are executing, the surrounding terrain data provided by the Digital Terrain Representative PRG 55 is added. As the vehicle 5 begins to move, the vehicle ground speed data 303, the wheel/track data 305, and the applied power data (not shown) from the vehicle 5 are then added as shown in the Calculation of Vehicle to Terrain Interaction Graph 310. The available tractive power for the subsurface soil condition is then continuously calculated to determine the ability of the vehicle to maintain a ‘Go’. The result of this continuous calculation is an enhancement of the Map Database 36, shown in FIG. 2, using the real-time vehicle-to-soil interaction data. This allows the vehicle 5 to maintain a ‘Go’ status as indicated by box 315.

FIG. 3 illustrates the dynamic VMPS 3 that uses terrain data 302, vehicle ground speed 303, GPS location information 304, wheel/track power and wheel/track speed data 305, and available tractive power data 305 (or wheel track speed 306) to overcome subsurface soil motion resistance (mu slip curve). The data is then processed to present ‘go’ ‘no go’ information 308 to the display 15 for reviewing by the operator 13 or 14.

It should be understood that the initial terrain data can be provided from several possible sources, including commercially available information, as may be presented from sources including ArcGIS or from classified military sources, which may be based on very detailed satellite imagery combined with more recent information from drones or other sources. However, this information is limited to the assessment of the surface. The dynamic VMPS then assesses the terrain based on the vehicle interaction with the soil condition created by the interaction between the vehicle and the deformable terrain surface. The dynamic VMPS then immediately updates the terrain data representation based on the interaction between the vehicle and the subsurface terrain condition and continues to complete those updates as the vehicle interacts with more of the various terrain units.

Vehicle ground speed is generated from two sources. One source is the global positioning sensor, which can identify how the vehicle moves across the terrain over time and therefore calculates the vehicle's ground speed. The dynamic VMPS may also determine vehicle ground speed based on the time required for the vehicle to reach various identifiable conditions from the terrain map combined with the onboard vehicle sensors' data for vehicle longitudinal acceleration combined with wheel speed, which is obtained from the internal information provided by the vehicle as soon as the vehicle initiates motion.

The wheel speed can come from speed sensor 28. It should be understood that “speed” is generic term and could mean rotation of the wheels, drive shaft or engine RPM. It could also be obtained from communicating with the engine subsystem 61 and transmission subsystem 62. The dynamic VMPS may also calculate vehicle speed based simply on the methodology by the vehicle operator uses to demand and control vehicle motion.

Wheel/track power generation information may be provided by speed sensor 28 and Load Sensor 27. It may also be calculated by the dynamic VMPS using whatever methodology the vehicle operator uses to demand and control vehicle motion. Additional sources for this information may be provided from the engine subsystem 61 and transmission subsystem 62.

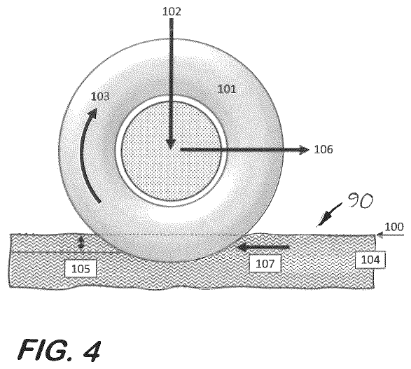

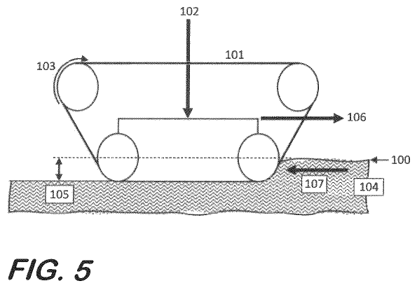

To describe the Mu-Slip graph, the dynamic VMPS identifies 3 the applied forward thrust, the overall vehicle speed, and the wheel or track speed. The forward thrust generated by the vehicle is divided by the vehicle's overall weight or normal force to calculate ‘Mu’. Slip is determined based on the overall vehicle speed and the track/wheel or drive train speed. When the speed of the track wheel is greater than the overall vehicle ground speed, slip has occurred as indicated by the relevant equations. The vehicle's normal force comes from communication with the suspension subsystem 63. Current engine torque is obtained by communication with the engine/generator system 61. The engine torque will be multiplied by the current gear taken from the transmission subsystem 62 to calculate wheel torque. Torque times Rolling Radius of the tire is Thrust. Thrust divided by wheel normal force is ‘mu’. This relationship is identified in FIGS. 4 and 5 and the associated reference equations.

To help the operator know if the vehicle can keep moving through soft or uneven ground, the dynamic VMPS uses known information about how the tires or tracks interact with the soil underneath. This interaction is measured separately from the vehicle itself. The way this interaction is measured for different subsurface soils is shown in FIGS. 4 and 5.

Reference number 100 soil highlights surface soil characteristics is available from various sources online, and is downloaded to the Map Database 36. Digital terrain representation program 55 loads the data and calculates basic information, such as slope from elevation. The GPS 56 tells the vehicle operator the vehicle's location on the map.

In FIGS. 4 and 5, the tire/track 101 is a physical vehicle component. The dimensions of the tire/track 101 are defined by the suspension subsystem 63, the tire monitoring/adjustment subsystem 64, and the mobility control subsystem 65. The force weight 102 is the vehicle's weight and is calculated by the suspension subsystem 63. The power/torque calculation 103 determined by measurement sensors incorporated into the test fixture, is applied to the tire/track 101. The engine torque is obtained from the engine subsystem 61. The engine torque will be multiplied by the current gear, from the transmission subsystem 62, to calculate wheel torque. Torque times multiplied by tire's rolling radius determines thrust. The subsurface soil information 104 is obtained from the dynamic VMPS 3.

Tire/track sinkage information 105 may be provided from several sources. The suspension system ride height sensors are initially set based on operation over a hard or non-deformable road surface. As sinkage occurs, the suspension subsystem provides information to dynamic VMPS 3 by identifying the loss of ground clearance of the vehicle as the tires or tracks sink into the deformable terrain. The dynamic VMPS 3 may also calculate the sinkage based on the increase in motion resistance as the vehicle 5 sinks further into the terrain's surface 90. A reduction in vehicle speed determines the increase in motion resistance while the applied thrust remains constant. Additional sensors may be used to determine the change in ground clearance by directly measuring the distance between the bottom of the vehicle and the untracked terrain surface. Alternately, it can be inferred without the use of a sensor by comparing current vehicle performance, as shown by a Mu-Slip curve, against the data in the tire/track interaction library 54.

Forward motion data 105 comes from the GPS 56 or from sensors (Force and displacement over time) available on the vehicle. Subsurface Soil Resistance to Motion data 107 is calculated by the dynamic VMPS 3 using forward thrust 103, the slope data, and comparing to tire/track interaction library 54.

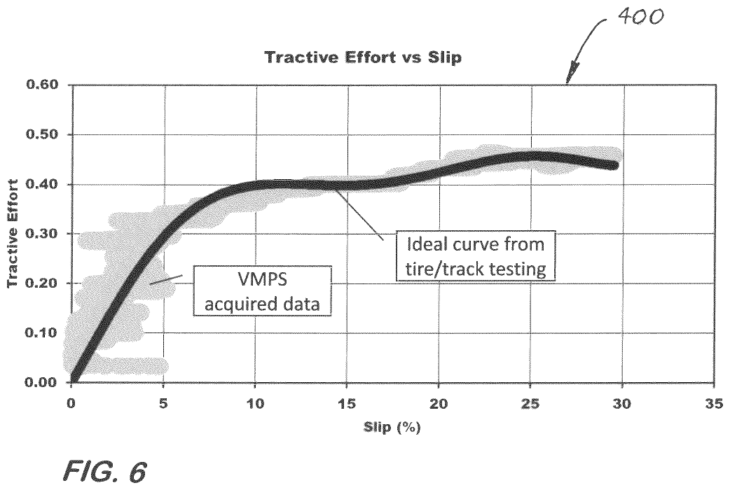

FIG. 6 is a graph showing the tractive performance with respect to the wheel/track slip according to the following formulas.

$$τ = \frac{T F}{A}$$

$$j = s * L$$

where, A=total contact area of tractive devices

The data sources are the global position sensor 56 and the engine/generator subsystem 61, the transmission subsystem 62, which are used to calculate wheel speed and thrust. Suspension system 63 calculates the normal force on the wheel/track. The data is then used to calculate the tractive effort (Mu-Slip points) described above.

For a given tire or track and a given soil condition (soil type, strength, moisture content, gradation, chemical composition, compaction) the interaction between the tire/track and the soil as identified in FIG. 5 is a constant. The vehicle simulation then utilizes this constant relationship to establish the ability of vehicle 5 to continue. A specific soil type 100 is selected and placed in the measurement fixture. The tire or track assembly of interest 101 is placed in the fixture. A vertical force or weight 102 is applied to the wheel or tire. The subsurface soil deformation 105 is then measured. This value is used to determine how much load can be carried by the soil. In this condition, power in the form of torque is applied to the tire or track, and the resultant subsurface soil deformation 105 and the ability of the tire or track to produce forward motion 106, overcoming the subsurface soil resistance 107, is established. This relationship is constant for a given tire or track to subsurface soil condition. Multiple measurements are made for different soil conditions and different tires or tracks. This information is integrated into vehicle simulation. The methodology to incorporate this data, which defines the vehicle to subsurface soil interaction, is described as follows.

The equation below defines the pressure-sinkage relationship of the soil (Bernstein). This method may be used within the VMPS module to calculate the ability of the vehicle to overcome the motion resistance associated with the subsurface soil conditions and therefore determine whether the vehicle can maintain a ‘Go’ condition.

$$p = K * {Z}^{n}$$

where,
p=normal pressure
K=sinkage coefficient
Z=sinkage depth
n=sinkage exponent

$${μ}_{s o i l} = \frac{Σ F}{W} - {μ}_{v e h} n = \frac{Z}{N * L * {μ}_{s o i l}} - 1$$

$$K = \frac{W}{2 * N * b * L * {Z}^{n}}$$

where,
μₛₒᵢₗ=motion resistance due to soil deformation
F=force required to overcome motion resistance
W=vehicle weight
μᵥₑₕ=motion resistance of the vehicle driveline
N=number of tractive devices
L=contact length of tractive devices
b=wheel/track width

The equation below establishes the tractive slip relationship for the subsurface soil condition (Janosi, Hanamoto), as established from the measurements gained from the figure above.

$$τ = ( c + p * tan ϕ ) * ( 1 - {e}^{( - j / k )} )$$

where,
τ=tractive stress of soil
c=cohesion
ϕ=angle of internal friction
j=shear displacement of the traction device
k=modulus of shear deformation

These parameters quantify the subsurface soil reaction to the tire or track that interacts with the subsurface soil condition. These parameters identify the given subsurface soil condition as a function of texture (fine/coarse grained), density, moisture content, etc.

$$\begin{matrix}ρ \\ T \\ PI \\ ⋮ \\ θ\end{matrix} {\to }^{yields} \{ \begin{matrix}K \\ n \\ c \\ φ \\ k\end{matrix} \} {\to }^{Input} \begin{matrix}Computational \\ and control \\ algorithms\end{matrix} {\to }^{yields} \begin{matrix}Vehicle Tractive \\ Performance\end{matrix}$$

where,
ρ=density
T=texture, expressed as present sand/silt/clay to distinguish fine/course grained
PI=plasticity index
Θ=moisture content

Using the known characteristics of the vehicle, we can convert its performance data into a format similar to soil shear-displacement test results. By using specific measurements (c and _{φ} from terramechanical tests and treating j as the independent variable, we can solve for k using minimization techniques.

The following equations help determine how the tire or track interacts with the soil underneath, based on the power applied to the wheels or tracks, their speed, and the vehicle's ground speed.

FIG. 6 is a graph showing the tractive performance for wheel/track slip. The sources shown in the graph are from the global position sensor 56, the engine speed 61, and torque 62. Suspension subsystem 63 calculates the normal force on the wheel/track. Example tractive performance for wheel/track slip follows the equation:

$$T E = \frac{T F}{W}$$

$$s = \frac{{V}_{t} - {V}_{a}}{{V}_{t}}$$

where,
TE=tractive effort
TF=Tractive Force as a result of the power applied
s =percent slip
Vₜ=wheel or track speed
Vₐ=actual vehicle speed

$$τ = \frac{T F}{A}$$

$$j = s * L$$

where,
A=total contact area of tractive devices

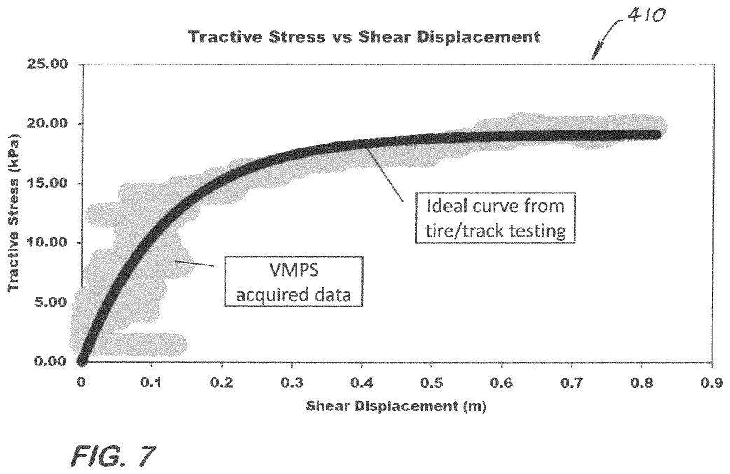

FIG. 7 is a graph 410 that converts TE vs Slip data to tractive stress vs shear displacement. The conversion provides a more detailed analysis of the vehicle's interaction with the terrain, thus helping it predict performance under various conditions. The graphs are generated using the vehicle dimensional multibody dynamic model 201, the tire/track/soil interaction data 202, and the vehicle 3-dimensional multibody dynamics deformable soil simulation program 203.

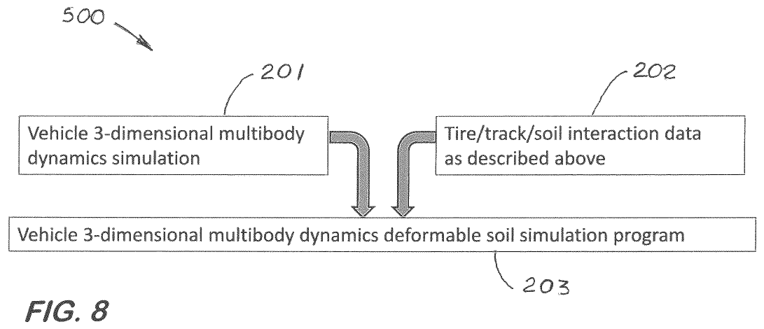

FIG. 8 is a flow chart 500 showing how the vehicle 3-dimensional multibody dynamics simulation is combined with the tire/track soil interaction data to create the vehicle 3-dimensional multibody dynamics deformable soil simulation program.

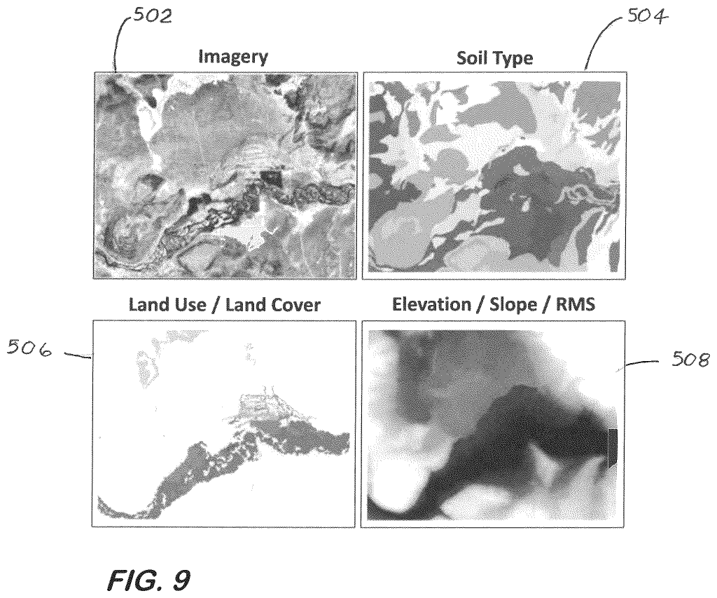

FIG. 9 shows four-layered Illustrations 502, 504, 506, and 508 of Local GIS Terrain Data loaded into the dynamic VMPS.

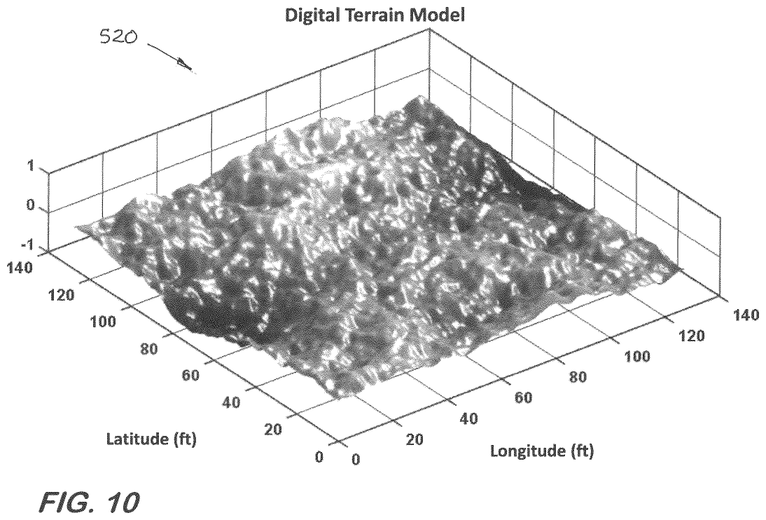

FIG. 10 is a high-resolution image 520 of GIS data.

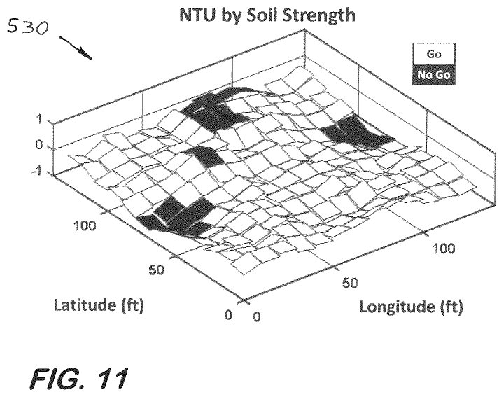

FIG. 11 is an image 530 that illustrates ‘Go’ (White) or ‘No Go’ (Black) Terrain sections based on soil type.

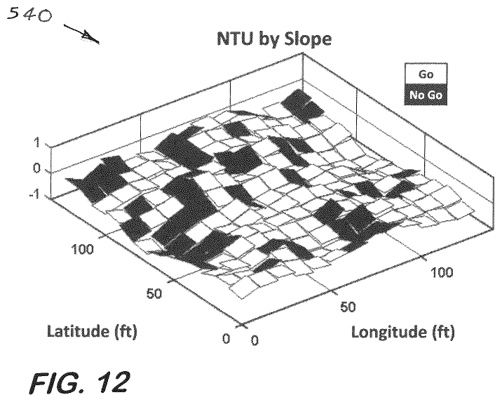

FIG. 12 is an image 540 that illustrates ‘Go’ (White) or ‘No Go’ (Black) Terrain Sections Based on Slope.

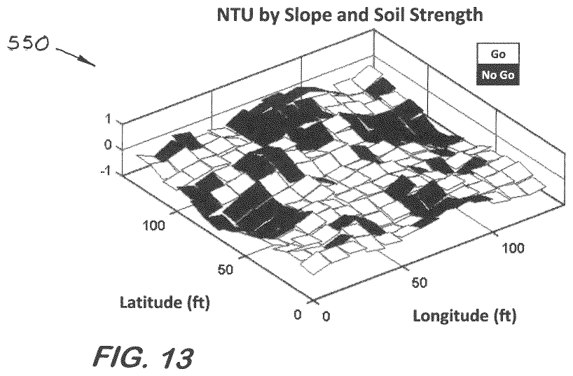

FIG. 13 is an image 550 that illustrates ‘Go’ (White) or ‘No Go’ (Black) Terrain Sections Based on Slope and Soil strength.

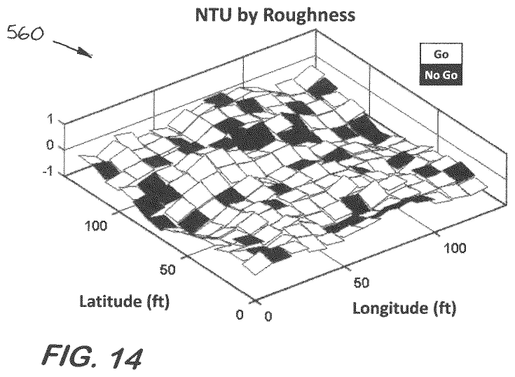

FIG. 14 is an image 560 that illustrates ‘Go’ (White) or ‘No Go’ (Black) terrain sections based on roughness.

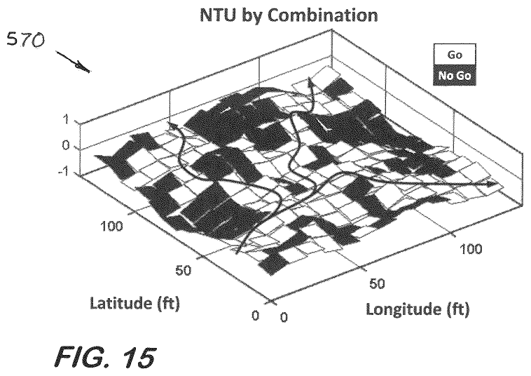

FIG. 15 is an image 570 that illustrates Go' (White) or ‘No Go’ (Black) terrain sections based on slope, soil condition, and roughness.

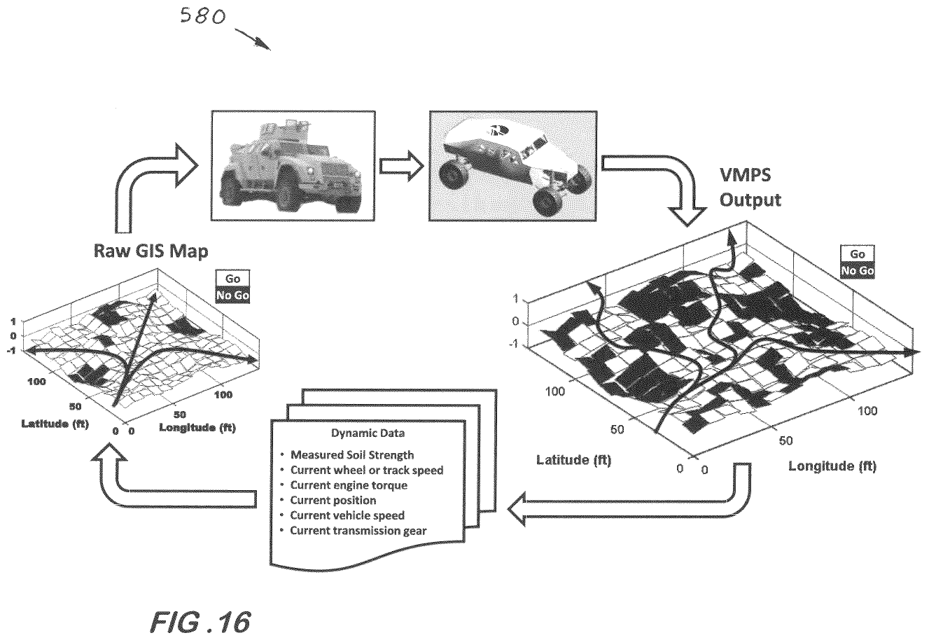

FIG. 16 is a flow chart 580 that illustrates the dynamic VMPS continuous analysis for ‘Go’ and ‘No Go’ terrain sections as the vehicle moves over the terrain.

An important feature of the VMPS is its ability to identify possible travel routes and assign predictive values to each route, presenting them as ‘Go/No-Go’ travel routes. When the vehicle is moving along a route the vehicle mobility prediction system (VMPS) continuously assesses the interaction between the vehicle and the subsurface soil conditions. It also assesses the vehicle's capability to navigate subsurface soil conditions and determines whether the vehicle can maintain movement on its current or alternative routes. Routes that the vehicle can follow are deemed ‘Go’ routes. If the vehicle is currently on a ‘Go’ route, the vehicle may continue the ‘Go’ route. If the VMPS 3 integrated use of software, and database information, determines that the route, by assessing the interaction between the vehicle 5 and the subsurface soil 100, is beyond the vehicle's capabilities, the route is identified as a ‘No-Go’ route and the vehicle is directed either to stop or follow an alternative ‘Go’ route. The VMPS updates the vehicle's status and may alert the vehicle operator to potential ‘No-Go’ conditions, enabling manual route adjustments.

An example of the VMPS at work is seen when the vehicle is moving along a route. The vehicle's motion can cause the tire or track to penetrate the surface when a deformable terrain surface is present, resulting in sinkage and contact with subsurface material. VMPS 3 measures subsurface conditions in real time, providing crucial information to determine if the vehicle can maintain a ‘Go’ condition. It continuously updates the vehicle's status, alerting the vehicle operator to potential ‘No-Go’ conditions, which enables path adjustments to prevent immobilization. The VMPS 3 operates continuously, receiving and processing real-time vehicle data, terrain characteristics, and soil mechanics to provide the vehicle operator with actionable insights. The simulation provides a model of the real-time interaction between vehicle 5 and the terrain 90. It predicts how the vehicle will behave in different soil conditions such as soft sand, mud, and rocky terrain. It calculates whether vehicle 5 has enough tractive power to continue moving and provides dynamic updates as it moves and encounters new terrain.

By evaluating multiple travel paths and assigning predictive values, the VMPS 3 provides the vehicle operator with a clear understanding of the potential risks and benefits associated with each route. This information enables the vehicle operator to make informed decisions, selecting the path that best aligns with the mission objectives and current conditions.

Predictive values help identify ‘Go’ and ‘No-Go’ routes, allowing the VMPS 3 to highlight paths that are safe to travel and those that pose significant risks. This capability is essential for avoiding routes that could lead to vehicle immobilization, damage, or other operational failures, thereby enhancing the overall safety and reliability of the vehicle's operation. VMPS 3 ensures that the vehicle can adapt to changing terrain and environmental conditions in real time by continuously assessing and updating the predictive values of various routes. This dynamic optimization helps maintain optimal vehicle performance, reducing the likelihood of encountering obstacles or difficult terrain that could hinder progress. Providing the vehicle operator with predictive values for different routes reduces the cognitive load and stress associated with navigating challenging terrains. The VMPS offers actionable insights and recommendations, supporting the vehicle operator in making the best possible decisions under varying conditions.

### Dynamic VMPS Provides Predictive Value or Score on Possible Routes

An important benefit of the dynamic VMPS 3 and its ability to provide predictive values or scores on possible routes. The dynamic VMPS 3 identifies and continuously assesses travel routes, presenting them as ‘Go/No-Go’ routes based on real-time data. The dynamic VMPS 3 offers several benefits. It identifies possible travel routes and assigns predictive values to each route, presenting them as ‘Go/No-Go’ travel routes. It continuously evaluates the interaction between the vehicle 3 and the subsurface soil conditions to determine whether the vehicle 5 can maintain movement on its current or alternative routes. The dynamic VMPS 3 continuously updates the vehicle's status, alerting the vehicle operator to potential ‘No-Go’ conditions and enabling manual route adjustments to prevent immobilization. By evaluating multiple travel paths and assigning predictive values, the dynamic VMPS 3 provides the vehicle operator 13 or 14 with a clear understanding of the potential risks and benefits associated with each route. This information helps the vehicle operator 13 or 14 make informed decisions, selecting the path that best aligns with the mission objectives and current conditions. The dynamic VMPS 3 ensures that vehicle 5 can adapt to changing terrain and environmental conditions in real time, maintaining optimal vehicle performance and reducing the likelihood of encountering obstacles or difficult terrain 90.

An example provided in the document illustrates how the dynamic VMPS 3 measures subsurface conditions in real time, offering actionable insights and recommendations to support the vehicle operator 13 or 14 in making the best possible decisions under varying conditions. This dynamic optimization helps maintain optimal vehicle performance and enhances overall safety and reliability.

Providing predictive values or scores on possible routes enhances decision-making by providing vehicle operators with clear assessments of potential routes, helping them make informed choices by presenting predictive values for each route. The dynamic VMPS 3 continuously evaluates the interaction between the vehicle 5 and the subsurface soil conditions, ensuring the vehicle 5 can maintain movement on its current or alternative routes. It continuously updates the vehicle's status, alerting the vehicle operator 13 or 14 to potential ‘No-Go’ conditions and enabling manual route adjustments to prevent immobilization. The dynamic VMPS 3 ensures that vehicle 5 can adapt to changing terrain and environmental conditions in real-time, maintaining optimal vehicle performance and reducing the likelihood of encountering obstacles or difficult terrain. By identifying hazardous areas and safer routes, the dynamic VMPS 3 helps avoid paths that could lead to vehicle immobilization or damage, enhancing overall safety and reliability. The dynamic VMPS 3 optimizes resource management by selecting routes that minimize fuel consumption, reduce travel time, and limit vehicle wear and tear, contributing to mission success. Additionally, the dynamic VMPS 3 simplifies complex data into an easily understandable format, making it accessible for vehicle operators who may not have technical expertise, and providing actionable insights and recommendations. These benefits collectively enhance vehicle operations' effectiveness, safety, and reliability in challenging terrains.

We claim:

1. A vehicle configured for operation over rugged terrain, comprising:
a. a vehicle body;
b. a digital controller network located within the vehicle body;
c. a vehicle control computer connected to the digital controller network, the Vehicle Control Computer configured to manage engine power, acceleration, braking, and terra-mechanical systems of the vehicle;
d. a dynamic vehicle mobility prediction system in communication with the vehicle control computer, the dynamic vehicle mobility prediction system including:
an onboard vehicle simulation module configured to analyze real-time vehicle dynamics and terrain interactions;
a deformable terrain soil program configured to assess vehicle-to-soil reactions;
a tire/track soil interaction library configured to provide data on soil interactions;
a digital terrain representation program configured to offer a 3-D model of the terrain; and,
a global positioning sensor configured to determine the vehicle's position and speed relative to the terrain model;
e. a plurality of sensors connected to the digital controller network, the sensors configured to collect real-time data on temperature, pressure, load, vibration, speed, voltage, and current, and transmit the data to the vehicle control computer;
f. a plurality of vehicle subsystems, including:
an engine/generator subsystem configured to control engine parameters such as throttle, RPM, and torque;
a transmission subsystem configured to manage gear selection and shift points;
a suspension subsystem configured to adjust ride height and suspension compliance;
a tire monitoring and inflation subsystem configured to control tire pressure;
a mobility control subsystem configured to manage drive locks, tire pressure, and suspension adjustments;
a powertrain control subsystem configured to ensure sufficient tractive power to navigate challenging terrains;
g. a navigation subsystem configured to guide the vehicle;
h. an obstacle avoidance system configured to detect and avoid obstacles;
i. a map database management system configured to store and present spatial information about the terrain, identify possible travel routes, known obstacles, and ‘Go/No-Go’ areas, and continuously update this information based on real-time data; and
j. a communication system comprising wireless communication, a digital controller network interface, an onboard diagnostic interface, the communication system configured to gather and transmit data between the dynamic vehicle mobility prediction system, the vehicle control computer, and external sources;
k. wherein the dynamic vehicle mobility prediction system is configured to continuously collect and process data from the sensors and external sources, assess the vehicle's current state and predict future performance using algorithms and simulations, send control commands to adjust the vehicle's subsystems for optimal performance, and provide real-time updates and recommendations to the vehicle operator through a display interface, including information about the vehicle's current path, projected path, obstacles, and recommended adjustments to vehicle settings;
l. wherein the dynamic vehicle mobility prediction system is further configured to identify possible travel routes, assign predictive values to each route, present them as ‘Go’ and ‘No-Go’ travel routes, evaluate the vehicle's capability to navigate subsurface terrain conditions, predict whether the vehicle can maintain movement on its current or alternative routes, and immobilize the vehicle if a ‘No-Go’ route is predicted to prevent it from following the designated path; and,
m. wherein the dynamic vehicle mobility prediction system continuously measures subsurface conditions in real-time, updates the vehicle's status, alerts the vehicle operator to potential ‘No-Go’ conditions, and enables route adjustments to prevent immobilization.

2. The vehicle as recited in claim 1, wherein the vehicle control computer is further configured to manage engine power, acceleration, braking, and terra-mechanical systems of the vehicle.

3. The vehicle as recited in claim 1, wherein the plurality of sensors includes sensors configured to collect data on temperature, pressure, load, vibration, speed, voltage, and current.

4. The vehicle as recited in claim 1, wherein the dynamic vehicle mobility prediction system includes a deformable terrain soil program configured to assess soil reactions.

5. The vehicle as recited in claim 1, wherein the navigation subsystem is further configured to provide real-time updates and recommendations to the vehicle operator.

6. A method for enhancing vehicle mobility over challenging terrains, comprising:
a. collecting real-time data on vehicle and environmental conditions using a plurality of sensors;
b. analyzing the collected data to assess vehicle dynamics and terrain interactions using a dynamic vehicle mobility prediction system;
c. determining optimal travel paths based on the analysis;
d. providing real-time updates and recommendations to the vehicle operator;
e. adjusting vehicle subsystems to maintain optimal performance based on the real-time data and analysis;
f. wherein the dynamic vehicle mobility prediction system is configured to continuously collect and process data from the sensors and external sources, assess the vehicle's current state and predict future performance using algorithms and simulations, send control commands to adjust the vehicle's subsystems for optimal performance, and provide real-time updates and recommendations to the vehicle operator through a display interface, including information about the vehicle's current path, projected path, obstacles, and recommended adjustments to vehicle settings;
g. wherein the dynamic vehicle mobility prediction system is further configured to identify possible travel routes, assign predictive values to each route, present them as ‘Go’ or ‘No-Go’ travel routes, evaluate the vehicle's capability to navigate subsurface terrain conditions, predict whether the vehicle can maintain movement on its current or alternative routes, and immobilize the vehicle if a ‘No-Go’ route is predicted to prevent it from following the designated path; and,
h. wherein the dynamic vehicle mobility prediction system continuously measures subsurface conditions in real-time, updates the vehicle's status, alerts the vehicle operator to potential ‘No-Go.’

7. The method as recited in claim 6, wherein the step of analyzing the collected data includes using a deformable terrain soil program to assess soil reactions.

8. The method as recited in claim 6, wherein the step of determining optimal travel paths includes using a navigation subsystem to guide the vehicle along optimal paths.

9. The method as recited in claim 6, wherein the step of providing real-time updates and recommendations includes using an obstacle avoidance system to detect and avoid obstacles.

10. The method as recited in claim 6, wherein the step of adjusting vehicle subsystems includes managing engine power, acceleration, braking, and terra-mechanical systems of the vehicle.

11. The method as recited in claim 6, wherein the step of continuously collecting real-time data includes using sensors configured to collect data on temperature, pressure, load, vibration, speed, voltage, and current.

12. The method as recited in claim 6, wherein the step of providing real-time updates and recommendations to the vehicle operator includes displaying information about the vehicle's current path, projected path, obstacles, and recommended adjustments to vehicle settings.

13. The method as recited in claim 6, wherein the step of identifying possible travel routes includes assigning predictive values to each route and presenting them as ‘Go’ or ‘/No-Go’ travel routes.

14. The method as recited in claim 6, wherein the step of evaluating the vehicle's capability to navigate subsurface terrain conditions includes predicting whether the vehicle can maintain movement on its current or alternative routes.

15. The method as recited in claim 6, wherein the step of immobilizing the vehicle if a ‘No-Go’ route is predicted includes preventing the vehicle from following the designated path.

16. The method as recited in claim 6, wherein the step of continuously measuring subsurface conditions in real-time includes updating the vehicle's status and alerting the vehicle operator to potential ‘No-Go’ conditions.

17. The method as recited in claim 6, wherein the step of enabling route adjustments to prevent immobilization includes providing actionable insights and recommendations to the vehicle operator.

18. A dynamic vehicle mobility prediction system for an all-terrain vehicle under the control of a vehicle operator that includes an engine/generator subsystem configured to control engine parameters such as throttle, RPM, and torque, a transmission subsystem configured to manage gear selection and shift points, a suspension subsystem configured to adjust ride height and suspension, and a tire monitoring subsystem, a digital controller network, a vehicle control computer connected to the controller area network, the vehicle control computer configured to manage the engine/generator subsystem, the transmission system, the suspension system, and the tire monitoring system, the vehicle mobility prediction system comprising:
an onboard vehicle simulation module configured to analyze real-time vehicle dynamics and terrain interactions;
a dynamic vehicle mobility prediction system, that includes a deformable terrain soil program configured to assess soil reactions, a tire/track soil interaction library configured to provide data on soil interactions, a digital terrain representation program configured to offer a 3D model of the terrain, a global positioning sensor configured to determine the vehicle's position and speed relative to the terrain model, and a plurality of sensors connected to the digital controller network, the sensors configured to collect real-time data on temperature, pressure, load, vibration, speed, voltage, and current, and transmit the data to the vehicle control computer;
a navigation subsystem configured to guide the vehicle;
an obstacle avoidance system configured to detect and avoid obstacles; and
a map database management system configured to store and present spatial information about the terrain, identify possible travel routes, known obstacles, and ‘Go/No-Go’ areas, and continuously update this information based on real-time data;
wherein the dynamic vehicle mobility prediction system is configured to continuously collect and process data from the sensors, assess the vehicle's current state and predict future performance using the onboard vehicle simulation module, the deformable terrain soil program, the tire/track soil interaction library, and the digital terrain representation program, the dynamic vehicle mobility prediction system also configured to send control commands to the engine/generator subsystem, the transmission subsystem, the suspension subsystem, and the tire monitoring subsystem to optimize the performance of the vehicle as it moves continuously along a route;
wherein the dynamic vehicle mobility prediction system is also configured to identify possible travel routes, assign predictive values to each route, present them as ‘Go’ pr ‘No-Go’ travel routes, evaluate the vehicle's capability to navigate subsurface terrain conditions, predict whether the vehicle can maintain movement on its current or alternative routes, and immobilize the vehicle if a ‘No-Go’ route is predicted to prevent it from following the designated route; and,
wherein the dynamic vehicle mobility prediction system continuously measures subsurface conditions in real-time, accesses the vehicle's subsystems, alerts the vehicle operator to potential ‘No-Go’ conditions, and enables route adjustments to prevent immobilization.

19. The vehicle as recited in claim 18, wherein the vehicle operator is a human located inside the vehicle; a human located remotely from the vehicle; or an autonomous system.

20. The vehicle as recited in claim 18, further including a display interface located inside the vehicle, the display interface configured to provide real-time updates and recommendations from the dynamic vehicle mobility prediction system.
